(19) United States
(12) Patent Application Publication
(10) Pub. No.: US 2019/0082226 A1
(43) Pub. Date: Mar. 14, 2019

(54) SYSTEM AND METHOD FOR RECOMMENDATIONS FOR SMART FOREGROUND VIEWING AMONG MULTIPLE TUNED CHANNELS BASED ON AUDIO CONTENT AND USER PROFILES

(71) Applicant: ARRIS Enterprises LLC, Suwanee, GA (US)

(72) Inventors: Shailesh Ramamurthy, Bengaluru (IN); Surya Prakesh Maheswaram, Miyapur (IN); Aravind Soundarajan, Bangalore (IN)

(21) Appl. No.: 15/699,385

(22) Filed: Sep. 8, 2017

(51) Int. Cl. H04N 21/472; H04N 21/422; H04N 21/488; H04N 21/6587

(52) U.S. Cl. CPC H04N 21/47214; H04N 21/6587; H04N 21/4882; H04N 21/42204

(57) ABSTRACT

A device is provided for use with a content providing device. The device includes: a first receiver that receives primary content data from a primary content source; a second receiver that receives secondary content data from a secondary content source; an output component that can output the primary content data and the secondary content data to the content providing device; an analyzing component that analyzes the secondary content data based on a tagged parameter associated with the secondary content data and generates an activation signal based on the analysis; and an indicating component that provides an indication to the user based on the activation signal.

### BACKGROUND OF THE INVENTION

Embodiments of the invention relate to devices and methods for notifying a user when desired content is available.

With so much content available (television, radio, Internet, podcasts, etc.), a user must often decide to consume one content over another, even if the user desires to consume both contents. For example, a user may desire to watch an awards show on television, but the awards show is on at the same time as an important soccer game. Furthermore, the user may only be interested when a goal is scored during the soccer game, but is interested in watching the entirety of the awards show. The user must then decide whether to watch the entire soccer game just to view the few instances when a team actually scores a goal, or to watch the awards show and potentially miss a very exciting goal being scored. There exists a need for a user to be notified of one desired content while watching another desired content, and to be able to decide what content to consume at that time.

### SUMMARY OF THE INVENTION

An aspect of the present invention is drawn to a device is provided for use with a content providing device. The device includes: a first receiver that receives primary content data from a primary content source; a second receiver that receives secondary content data from a secondary content source; an output component that can output the primary content data and the secondary content data to the content providing device; an analyzing component that analyzes the secondary content data based on a tagged parameter associated with the secondary content data and generates an activation signal based on the analysis; and an indicating component that provides an indication to the user based on the activation signal.

### BRIEF DESCRIPTION OF THE DRAWINGS

The accompanying drawings, which are incorporated in and form a part of the specification, illustrate example embodiments and, together with the description, serve to explain the principles of the invention. In the drawings:

FIG. 1 illustrates a method of notifying a user of desired content in accordance with aspects of the present invention;

FIG. 2 illustrates a device for notifying a user of desired content in accordance with aspects of the present invention;

FIG. 3A illustrates a user watching primary content in accordance with aspects of the present invention;

FIG. 3B illustrates a user choosing when to be notified of secondary content in accordance with aspects of the present invention;

FIG. 4 illustrates a chart showing how the device of FIG. 2 determines when to notify the user of the secondary content in accordance with aspects of the present invention;

FIGS. 5A-B illustrate different embodiments of how the device of FIG. 2 can notify the user of the secondary content in accordance with aspects of the present invention; and

FIG. 6 illustrates the user consuming the secondary content in accordance with aspects of the present invention; and

FIGS. 7A-B illustrate charts showing examples of the device of FIG. 2 determining a transition from speech to song or from song to speech.

### DETAILED DESCRIPTION OF THE EMBODIMENTS

The present invention provides a system and method to notify a user of a secondary content while the user is consuming a primary content.

Embodiments of the invention provide for a user to determine when to be notified of a secondary content while the user is consuming a primary content. The user may provide information to a second receiver such as identifying the secondary content and providing instances in which the user wishes to be notified about the secondary content. The secondary content is then analyzed for those instances the user is notified when such instances occur. In some embodiments, the user may then choose whether to switch to the secondary content or continue consuming the primary content. In other embodiments, the content may automatically switch from the primary content to the secondary content. In some embodiments, the secondary content is provided with trick play functionality such that the user may consume the secondary content beginning at a predetermined time prior to the switch from primary to secondary content. In other embodiments, the secondary content is provided without trick play functionality so the user may consume the secondary content in real time at the time the content is changed.

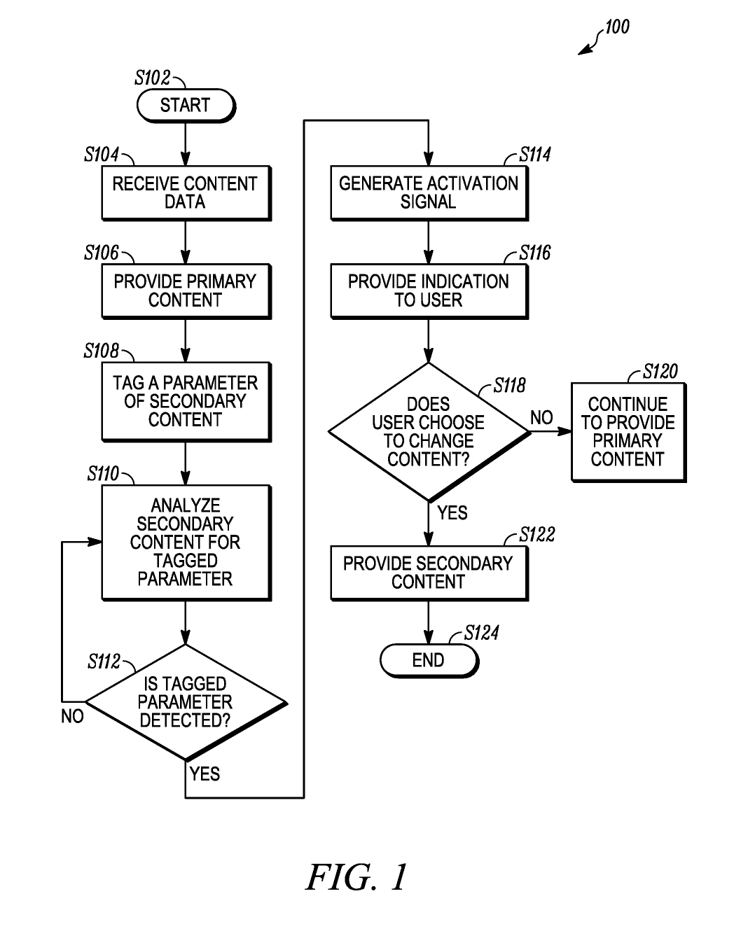

Aspects of the present invention will now be described with reference to FIGS. 1-6.

FIG. 1 illustrates a method of notifying a user of desired content in accordance with aspects of the present invention.

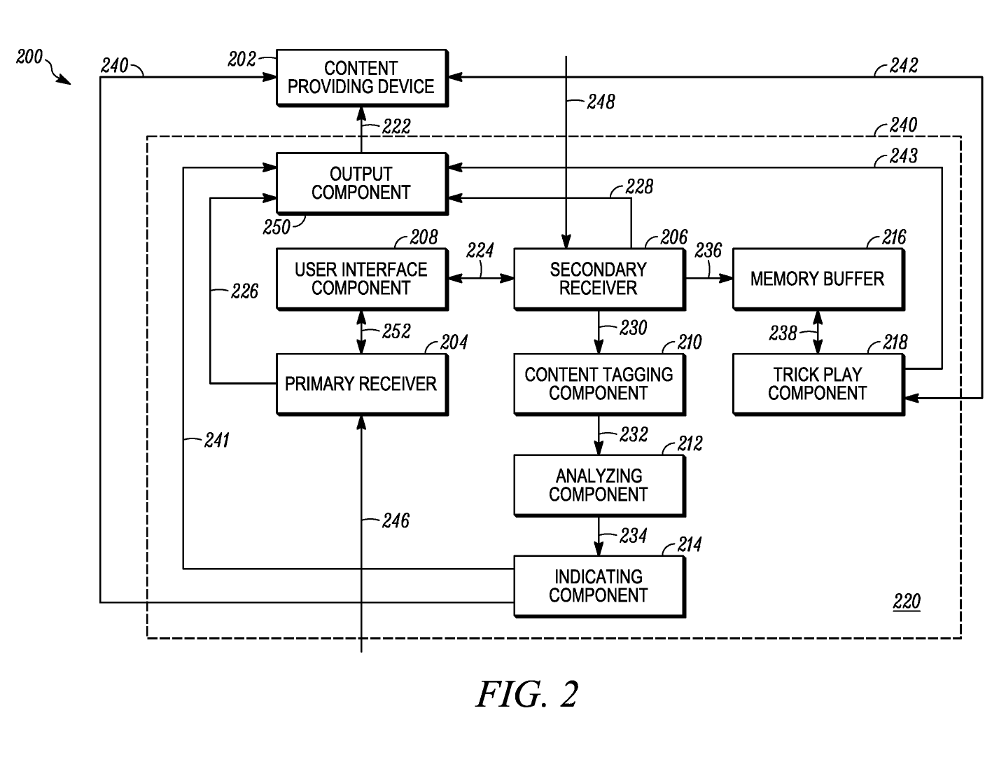

As shown in the figure, method 100 starts (S102) and content data is received (S104). This will be described in greater detail with reference to FIG. 2.

FIG. 2 illustrates a device for notifying a user of desired content in accordance with aspects of the present invention.

As shown in the figure, a system 200 includes a content providing device 202 and a device 220. Device 220 includes a receiver 204, a receiver 206, a user interface component 208, a content tagging component 210, an analyzing component 212, an indicating component 214, a memory buffer 216, a trick play component 218, and an output component 250.

Content providing device 202 communicates with output component 250 via communication channel 222, with indicating component 214 via communication channel 240, and with trick play component 218 via communication channel 242. Content providing device 202 may be any type of device or system capable of providing content to a user. Non-limiting examples of content providing device 202 include televisions, desktop computer monitors, laptop computer screens, mobile phones, tablet computers, e-readers, and MP3 players. As discussed throughout the specification, content may be video, audio, or a combination thereof. Content may also be provided by conventional methods like encoding or streaming.

Device 220 may be any type of device or system arranged to receive content from a content provider and send the content to a content providing device for a user to consume. Non-limiting examples of device 220 include set top boxes, Internet modems, and WiFi routers. Non-limiting examples of content providers include the Internet, cable, satellite, and broadcast.

Receiver 204 communicates with a content provider via communication channel 246 and with output component 250 via communication channel 226. Receiver 206 communicates with a content provider via communication channel 248, with output component 250 via communication channel 228, with content tagging component 210 via communication channel 230, with memory buffer 216 via communication channel 236, and with user interface component 208 via communication channel 224. Receiver 204 and receiver 206 may be any type of device or system arranged to receive content from a content provider and forward the content to another component for further operations.

User interface component 208 generates a graphic user interface (GUI) and communicates with receiver 204 via communication channel 252. User interface component 208 may be any type of device or system that provides a user the ability to input information to receiver 206. Non-limiting examples of user interface component 208 include a touchscreen, a remote control and screen combination, a keyboard and screen combination, and a mouse and screen combination.

Output component 250 additionally communicates with content providing device 202 via communication channel 222. Output component 250 may be any device or system arranged to receive content from receivers, manipulate the content such that it is in the proper format for user consumption, and provide the content to content providing device 202. A non-limiting example of output component 250 includes a set top box tuner that is arranged to decode content before providing it to a television for viewing. In some embodiments, output component 250 may include a plurality of set top box tuners, each of which is arranged to decode content from a different channel.

Content tagging component 210 additionally communicates with analyzing component 212 via communication channel 232. Content tagging component 210 may be any device or system arranged to tag a parameter of content. Non-limiting examples of parameters that may be tagged include volume, laughter, applause, cheering, specific words or phrases, and changing from speech to song or song to speech.

Tags may include explicit tags and implicit tags. Explicit tags may include provided choices, non-limiting examples of which include applause, song-to-speech, speech-to-song, etc. With implicit tags, even if the user did not choose any listed choices of tags, e.g., applause, song-to-speech, speech-to-song, etc., a recommendation notification may be provided based on a priori information. A priori information may be provided by any known system or method, non-limiting examples of which include initially provided information, e.g., training data, or adapted data developed through machine learning.

Analyzing component 212 additionally communicates with indicating component 214 via communication channel 234. Analyzing component 212 may be any device or system arranged to analyze data from content tagging component 210 and determine whether a tagged parameter has occurred.

Indicating component 214 additionally communicates with content providing device 202 via communication channel 240, and with output component 250 via communication channel 241. Indicating component 214 may be any device or system arranged to receive information regarding a tagged parameter from analyzing component 212 and provide an indication of the tagged parameter to a user via content providing device 202.

Memory buffer 216 additionally communicates with trick play component 218 via communication channel 238. Memory buffer 216 may be any device or system arranged to receive and store content from receiver 206. Non-limiting examples of memory buffer 216 include optical disk storage, magnetic disk storage, flash storage, and solid state storage.

Trick play component 218 additionally communicates with content providing device 202 via communication channel 242 and with output component 250 via communication channel 243. Trick play component 218 may be any device or system arranged to allow a user to manipulate playback of content in a time-shifted manner using conventional commands such as fast-forward, rewind, and pause.

In some embodiments, receiver 204, receiver 206, user interface component 208, content tagging component 210, analyzing component 212, indicating component 214, memory buffer 216, trick play component 218, and output component 250 are separate components. However, in other embodiments, at least two of receiver 204, receiver 206, user interface component 208, content tagging component 210, analyzing component 212, indicating component 214, memory buffer 216, trick play component 218, and output component 250 may be combined as a unitary component.

Further, in some embodiments, at least one of receiver 204, receiver 206, user interface component 208, content tagging component 210, analyzing component 212, indicating component 214, trick play component 218, and output component 250 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless, and via the Internet) to a computer, the computer may properly view the connection as a computer-readable medium. Thus, any such connection may be properly termed a computer-readable medium. Combinations of the above should also be included within the scope of computer-readable media.

Still further, in some embodiments, at least one of receiver 204, receiver 206, user interface component 208, content tagging component 210, analyzing component 212, indicating component 214, trick play component 218, and output component 250 may involve high complexity processing, e.g., analysis. Such high complexity tasks may be offloaded to another device, e.g., via a wireless network or through the Internet, rather than through the device itself, especially in cases where sophisticated complex algorithms may be involved.

For purposes of discussion, in one embodiment device 220 is a set top box that includes two receivers, receiver 204 and receiver 206. In other embodiments, device 220 may include more than two receivers to provide more than two different contents to the user. In an example embodiment, in order to provide content to the user, receiver 204 and receiver 206 first receive the content from the content provider. In this example, the content provider is a satellite television service, and receiver 204 and receiver 206 receive content from a satellite dish in communication with a satellite.

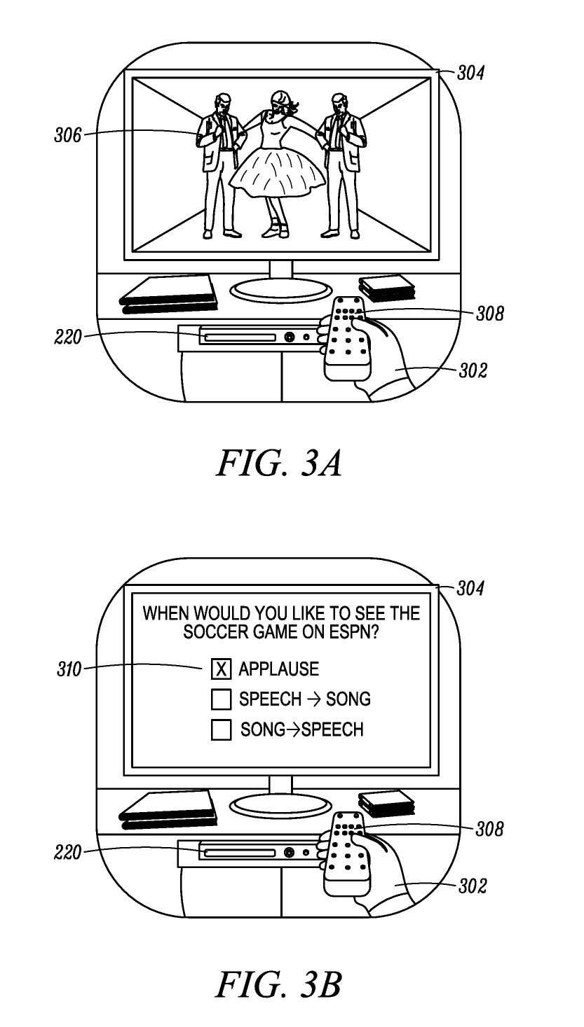

Returning to FIG. 1, after content data is received (S104), primary content is provided (S106). This will be further described with reference to FIG. 3A.

FIG. 3A illustrates a user watching primary content in accordance with aspects of the present invention.

As shown in the figure, a user 302 is watching primary content 306 on a television 304. Television 304 is connected to device 220. User 302 is holding a remote 308 to control device 220.

Returning to FIG. 2, and for purposes of discussion, suppose user 302 wants to watch a movie. Using remote 308, user 302 tunes to a television channel showing the desired movie as received by receiver 204. In one embodiment, user 302 may tune to the channel directly by pressing the channel number on remote 308. In another embodiment, user 302 may tune to the channel by navigating to the desired channel by interacting with a channel guide on receiver 204 via user interface component 208. Receiver 204 then sends the movie, which is primary content 306, to output component 250, which provides primary content 306 to content providing device 202.

Returning to FIG. 1, after primary content is provided (S106), a parameter of secondary content is explicitly or implicitly tagged (S108). This will be further described with reference to FIGS. 2 and 3B.

FIG. 3B illustrates a user choosing when to be notified of secondary content in accordance with aspects of the present invention.

As shown in the figure, user 302 is interacting with an interface content 310 on television 304. Suppose that user 302, while watching primary content 306, also desires to view another program, but desires to watch primary content 306 until a specific event occurs in the other program. For example, user 302 may desire to watch a soccer match, but user 302 only cares to see the match when a goal is scored.

To be notified when a goal is scored, in an example embodiment, user 302 provides information to device 220 about when to be notified. Because user 302 is watching primary content 306 from receiver 204, in an example embodiment, user 302 provides information to receiver 206.

Referring back to FIG. 2, to notify receiver 206 of notification preferences, user 302 uses remote 308 to activate user interface component 208 and navigate to the secondary content, which is the desired soccer match. For example, user 302 may navigate to a specific sports channel on the channel guide and find the desired soccer match there. In another example, user may navigate to the specific sports channel by directly choosing the channel. After user 302 finds the soccer match, user interface component 208 is used to select the soccer match.

Returning to FIG. 3B, after the soccer match is selected, interface content 310 provides user 302 the ability to choose when to watch the soccer match. User 302 may select to watch the soccer match only when a goal is scored. In some embodiments of the present invention, user 302 may select parameters that should be met in order to be notified. In other embodiments of the present invention, parameters may be preloaded within device 220. For example, if user 302 chose to watch a news program as the secondary content, a preloaded parameter may be that user 302 is notified whenever there is “breaking news”. Some embodiments may detect breaking new by detecting higher energy levels in the speakers voice and/or a speech recognition component that may identify predetermined phrases such as “live coverage,” “breaking news,” etc.

Referring back to FIG. 2, when user 302 selects one or more parameters, the selections are entered via user interface component 208 and forwarded to receiver 206. Receiver 206 then sends the information regarding the parameters to content tagging component 210, which creates explicit or implicit tags based on the desired parameters.

In addition, after user 302 selects the soccer match, receiver 206 begins to send soccer match content to memory buffer 216 to record portions of the soccer match.

In some embodiments, user 302 determines the secondary channel to be monitored. In some embodiments, when more than two receivers are available, user 302 may determine that a plurality of secondary channels be monitored for the tagged parameter. In some embodiments, an aspect of the tagged parameter is associated with a type of channel. For example, the sound of cheering may be associated with sports channels wherein all sports channels may be monitored for the tagged parameter, or a transition from speech-to-song may be associated with movie channels wherein all movie channels may be monitored for the tagged parameter.

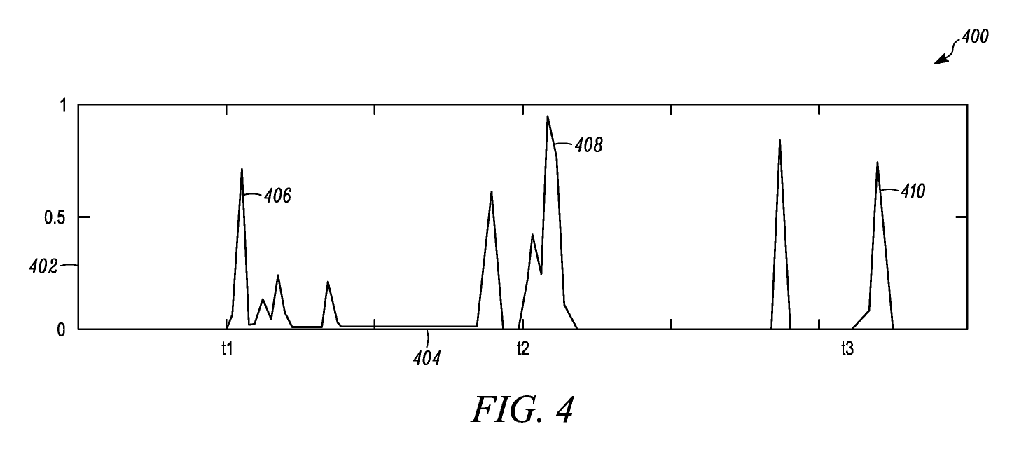

Returning to FIG. 1, after a parameter of secondary content is explicitly or implicitly tagged (S108), the secondary content is analyzed for the tagged parameter (S110). This will be further described with reference to FIGS. 2 and 4.

FIG. 4 illustrates a chart showing how device 220 determines when to notify the user of the secondary content in accordance with aspects of the present invention.

As shown in the figure, a chart 400 includes a y-axis 402, an x-axis 404, peak 406, peak 408, and peak 410. Y-axis 402 indicates amplitude of an audio signal, and x-axis 404 indicates time.

Returning to FIG. 2, when analyzing component 212 receives tagging information from content tagging component 210, analyzing component 212 begins to scan the desired secondary content to determine when the tagged parameters occur. In the current example, analyzing component 212 scans the desired soccer match to determine when a goal is scored.

Referring back to FIG. 4, analyzing component 212 analyzes the audio signals from the soccer match to determine when a goal is scored. When a goal is scored, the crowd typically cheers loudly for a sustained period of time, so analyzing component 212 searches for audio signals that indicate a high volume for a long period of time.

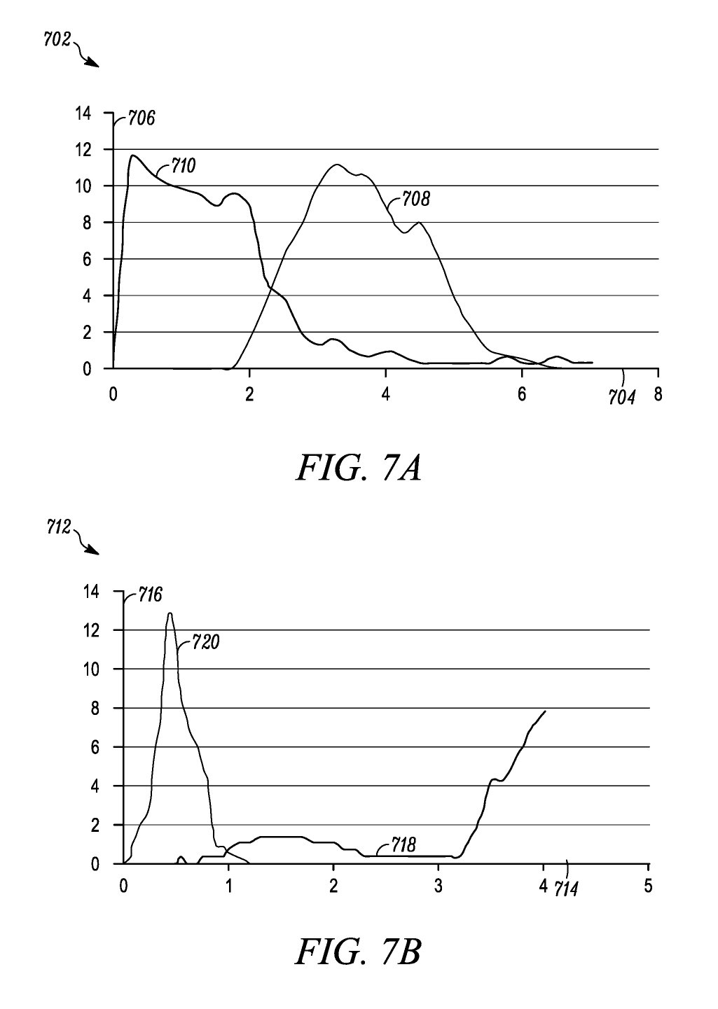

In another embodiment, user 302 may desire to be notified when a certain song begins on a satellite radio channel, so analyzing component 212 may search for audio signals that indicate a change from speech to song or song to speech. This will be further described with reference to FIG. 7.

Returning to FIG. 1, after the secondary content is analyzed for the tagged parameter (S110), the system determines whether a tagged parameter is detected (S112).

Referring back to FIG. 4, analyzing component 212 analyzes audio from the soccer match to determine if a goal is scored. At time t₁, the announcers are laughing, so analyzing component 212 determines that peak 406 is not high enough to indicate a goal was scored (NO at S112), and analyzing component continues to scan the soccer match to determine if a goal was scored (RETURN to S110).

At time t₂, the crowd is applauding a great play by the goalkeeper. Analyzing component 212 may determine that peak 410 is high enough to indicate a goal was scored, but it is not sustained for a long enough time to indicate a goal was scored (NO at S112). Analyzing component 212 therefore continues to scan the soccer match to determine if a goal was scored (RETURN to S110).

At time t₂, a goal is scored. Analyzing component 212 determines that peak 408 is high enough, and is sustained for long enough to indicate a goal was scored (YES at S112). Another embodiment in which analyzing component 212 may be used is in detecting the difference between speech and song. This will be further described with reference to FIGS. 7A-B.

FIGS. 7A-B illustrate charts showing examples of how device 220 may determine a transition from speech to song or from song to speech.

As shown in the figures, chart 702 includes x-axis 704, y-axis 706, curve 708, and curve 710. X-axis 704 shows the number of acoustical peaks per second, and y-axis 706 indicates the percentage of analyzed acoustical segments. Curve 708 is generated from speech data, and curve 710 is generated from song data. Generally, speech data includes more peaks per second and music data includes fewer peaks per second because singers generally hold notes longer than someone speaking would hold a sound. Therefore, for any given data segments analyzed, a high percentage of many peaks per second indicates speech, and a high percentage of few peaks per second indicates song.

Chart 712 includes x-axis 714, y-axis 716, curve 718, and curve 720. X-axis 714 indicates elapsed time, and y-axis 716 indicates the percentage of analyzed acoustical segments. Curve 718 is generated from music data, and curve 720 is generated from speech data. Generally, the length of the peaks for speech are shorter than the length of peaks for song because singers generally hold notes longer than someone speaking would hold a sound. Therefore, for any given data segments analyzed, a high percentage of very short peaks indicate speech, and any other peak data indicating long peaks indicates a song.

In the embodiment in which user 302 desires to listen to a specific song, analyzing component 212 looks to differentiate between speech and song. To do so, analyzing component 212 will analyze the audio signals from the desired channel. For example, when analyzing component 212 begins to analyze the signals, the signals may look like curves 708 and 720, indicating speech. At a later time, the signals may transition to look like curves 710 and 718, indicating song. At that time, analyzing component 212 will determine that the content has changed from speech to song.

In accordance with an aspect of the present invention analyzing component 212 may determine whether a tagged parameter is detected by analyzing sound of different frequency bands and energy within them—detecting certain audio textures. For example, the bands which have high energy due to a piccolo flute being played would be different from those bands which have a high energy due to a bass human male voice speaking. Such audio texture discrimination may be employed in embodiments of the present invention. In typical scenarios, the audio within the stream is compressed using frequency subband based audio coders. Hence, energy levels within frequency subbands can be readily obtained using the compressed audio stream. For instance, “scale factors,” or the like, readily provide this information in cases where mp3, AC3, or AAC is used.

Returning to FIG. 1, after the tagged parameter is detected (S112), an activation signal is generated (S114).

Returning to FIG. 2, analyzing component then creates an activation signal based on the scored goal and provides the activation signal to indicating component 214.

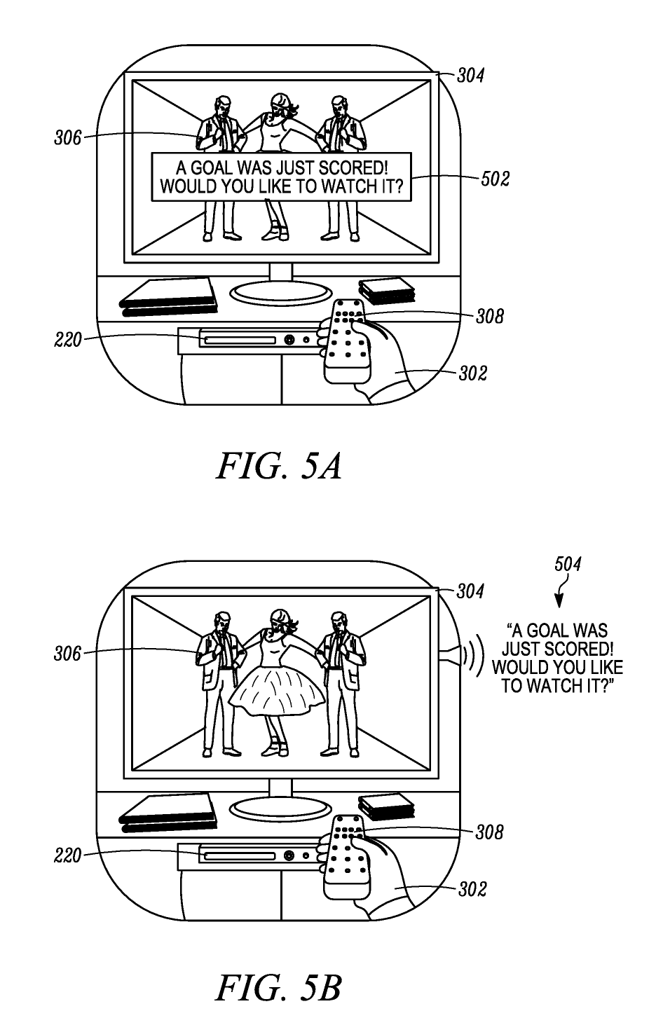

Returning to FIG. 1, after activation signal is generated (S114), an indication is provided to the user (S116). This will be described with further reference to FIGS. 2 and 5.

Returning to FIG. 2, indicating component 214 receives the activation signal from analyzing component 212 and sends an indication to content providing device 202. The indication notifies the user that the desired secondary content is available.

FIGS. 5A-B illustrate different embodiments of how device 220 can notify the user of the secondary content in accordance with aspects of the present invention.

As shown in the figures, user 302 is still watching primary content 306. In one embodiment, user 302 sees visual indicator 502 pop up on television 304 on top of primary content 306. In another embodiment, user 302 hears audible indicator 504 from television 304. When audible indicator 504 is used, the audio from primary content 502 may be automatically muted so user 302 can hear audible indicator 504. In other embodiments, an indication signal may be transmitted to another device, like a mobile phone, to provide the user additional notification that a goal was scored in the soccer match. Indications from the other device may include visual, audio, or haptic.

Returning to FIG. 1, after the indication is provided to the user (S116), the user decides whether to change the content (S118).

Referring back to FIG. 5, If user 302 decides not to watch the soccer match (NO at S118) even though a goal was scored, user 302 uses remote 308 to dismiss visual indicator 502 or audible indicator 504, depending on which indicator was used.

Returning to FIG. 1, receiver 204 continues to provide primary content 306 (S120).

If user 302 decides to watch the soccer match (YES at S118), user 302 uses remote 308 to indicate a desire to watch the soccer match.

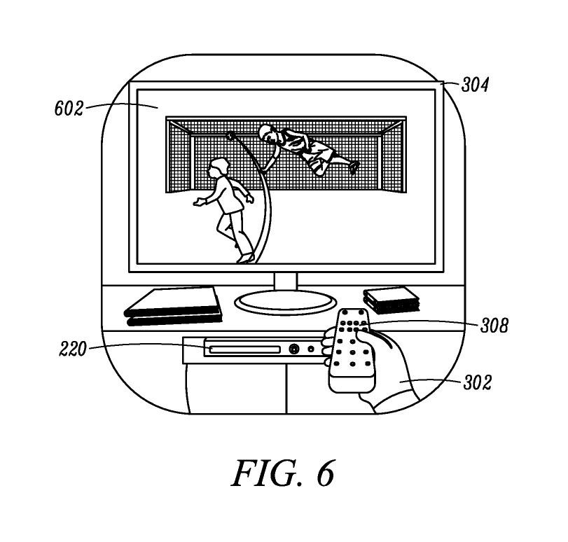

Returning to FIG. 1, the secondary content is provided (S122). This will be further described with references to FIGS. 2 and 6.

FIG. 6 illustrates the user consuming the secondary content in accordance with aspects of the present invention.

As shown in the figure, user 302 is watching secondary content 602 on television 304. In this example, secondary content 602 is the soccer match.

Returning to FIG. 2, in one embodiment receiver 206 receives the command from remote 208 and provides the command to memory buffer 216. Memory buffer 216 then provides soccer match content to trick play component 218. Trick play component 218 then automatically rewinds the soccer match to a predetermined time prior to generation of the activation signal. Rewinding may be necessary in instances such as the soccer match when, if content is switched in real time, user 302 would not actually see the goal being scored. Using trick play component 218, user 302 can also rewind and replay the goal to view it multiple times, if desired. In some embodiments, the predetermined delay is determined by device 220 based on the secondary content desired. For example, if user 302 desires to watch a sporting event as secondary content, the predetermined rewind time may be thirty seconds. In other embodiments, the predetermined delay may be determined by user 302 at the time the secondary content is chosen. After choosing the secondary content, user 302 may be prompted to define a rewind time to be provided to trick play component 218.

In another embodiment, receiver provides content directly to output component 250 without utilizing trick play component 218. In this embodiment, user 302 would miss the goal that was scored, so this embodiment of the invention may not be suitable for when the secondary content is a sporting event. However, this embodiment may be suitable for other types of secondary content. For example, user 302 may desire to listen to a specific song as secondary content when the song is announced on a radio station. In that case, the host announcing the song may be used as an explicit or implicit tag, and when the announcement is made and user 302 is notified, switching to the radio station immediately is desirable in order to listen to the song right away. If trick play component 218 were used, the user would have to listen to other content before the song started.

Returning to FIG. 1, after the secondary content is provided (S122), method 100 stops (S124).

In accordance with aspects of the present invention, a user watches a primary channel, and has the capability to choose (e. g. by click of a button on remote) any scene or small segment of interest. An audio analysis is performed, and notifications of similar events are provided when they occur in a secondary channel. For example, the user can choose a segment when a violin plays, and the audio analysis may recognize the audio texture (energy levels in different frequency bands) and subsequently search for it in secondary channels.

In general term, in an example embodiment, an explicit or implicit tag is chosen for a segment of interest in a primary channel. Audio analysis of the segment in the primary channel is performed to obtain audio texture or signature. Audio analysis in the secondary channel subsequently to look for a match to the audio texture or signature. Finally, an indication is provided to the user.

In summary, with so much content available, a user must often decide to consume one content over another, even if the user desires to consume both contents. As a result, a user may have a suboptimal viewing experience when consuming one content but knowing that the other content may be more desirable at any time.

The present invention addresses this problem by providing a user the ability to tag certain parameters, or to have certain parameters tagged, of a secondary content such that, while watching a primary content, the user would be notified when the tagged parameters of the secondary content are met. Upon notification, the user may decide to switch to the secondary content and consume the desired portion of the secondary content. In this manner, the user has the ability to consume the desired portions of multiple contents, resulting in a more satisfying experience.

Aspects of the present invention are conducive to practical implementation. In particular, an audio bitrate is typically much less than a video bitrate. For example, broadcast quality audio would be of the order of 200-300 kbps (very high quality Dolby audio stream is around 750 Kbps to 1 Mbps), whereas HD video is about 18 to 20 Mbps. Given audio bitrate and CPU cycles required to decode are far lower as compared to video decoding, scaling up to build receivers with multiple audio decode capability is relatively easy. The present invention relies on audio partial or full decoding, and hence can benefit from this feature.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a content providing device, said device comprising:
a first receiver operable to receive primary content data from a primary content source;
a second receiver operable to receive secondary content data from a secondary content source;
an output component operable to output the primary content data and the secondary content data to the content providing device;
an analyzing component operable to analyze the secondary content data based on a tagged parameter associated with the secondary content data and to generate an activation signal based on the analysis; and
an indicating component operable to provide an indication to the user based on the activation signal.

2. The device of claim 1, further comprising:
a user interface component operable to generate a graphic user interface to enable a user to tag the first parameter associated with the secondary content data,
wherein said output component is further operable to output the graphic user interface to the display.

3. The device of claim 2, wherein said user interface portion is operable to generate the graphic user interface to enable a user to tag as the first parameter associated with the secondary content data, one of the group consisting of a speech to song transition, a song to speech transition, audience sound amplitude, audience sound type, metadata, a preference profile and combinations thereof.

4. The device of claim 3,
wherein said user interface portion is operable to generate the graphic user interface to enable a user to tag as the first parameter associated with the secondary content data, one of the group consisting of a speech to song transition, a song to speech transition, audience sound type and combinations thereof, and
wherein said analyzing component is operable to frequency analyze the secondary content data based on the tagged first parameter and to generate the activation signal based on the frequency analysis.

5. The device of claim 4,
wherein said user interface portion is operable to generate the graphic user interface to enable a user to tag as the first parameter associated with the secondary content data, a preference profile, and
wherein the preference profile includes one of the group consisting of program title, program genre, program viewing times, program channels, and program broadcast characteristics.

6. The device of claim 1, further comprising:
a memory buffer operable to store a predetermined amount of the secondary content data; and
a trick play component operable to output the secondary content data from said memory buffer to the display,
wherein when said analyzing component generates the activation signal, and when said indicating component provides the indication to the user, said trick play component outputs the secondary content data from said memory buffer to the display.

7. The device of claim 1, further comprising:
a content tagging component operable to tag a parameter associated with the secondary content data,
wherein when said output component outputs the primary content data to the content providing device, said analyzing component generates the activation signal and said indicating component provides the indication to the user.

8. A method comprising:
receiving, via a first receiver, primary content data from a primary content source;
receiving, via a second receiver, secondary content data from a secondary content source;
outputting, via an output component, the primary content data and the secondary content data to the content providing device;
analyzing, via an analyzing component, the secondary content data based on a tagged parameter associated with the secondary content data;
generating, via the analyzing component, an activation signal based on the analysis; and
providing, via an indicating component, an indication to the user based on the activation signal.

9. The method of claim 8, further comprising:
generating, via a user interface component, a graphic user interface to enable a user to tag the first parameter associated with the secondary content data; and
outputting, via output component, the graphic user interface to the display.

10. The method of claim 9, wherein said generating, via a user interface component, a graphic user interface to enable a user to tag the first parameter associated with the secondary content data comprises generating the graphic user interface to enable a user to tag as the first parameter associated with the secondary content data, one of the group consisting of a speech to song transition, a song to speech transition, audience sound amplitude, audience sound type, metadata, a preference profile and combinations thereof.

11. The method of claim 10,
wherein said generating, via a user interface component, a graphic user interface to enable a user to tag the first parameter associated with the secondary content data comprises generating the graphic user interface to enable a user to tag as the first parameter associated with the secondary content data, one of the group consisting of a speech to song transition, a song to speech transition, audience sound type and combinations thereof, and
wherein said analyzing, via an analyzing component, the secondary content data based on the tagged parameter comprises frequency analyzing the secondary content data based on the tagged first parameter and to generate the activation signal based on the frequency analysis.

12. The method of claim 11,
wherein said wherein said generating, via a user interface component, a graphic user interface to enable a user to tag the first parameter associated with the secondary content data comprises generating the graphic user interface to enable a user to tag as the first parameter associated with the secondary content data, a preference profile, and
wherein the preference profile includes one of the group consisting of program title, program genre, program viewing times, program channels, and program broadcast characteristics.

13. The method of claim 8, further comprising:
storing, via a memory buffer operable to store a predetermined amount of the secondary content data; and
outputting, via a trick play component, the secondary content data from the memory buffer to the display.

14. The method of claim 13, further comprising:
tagging, via a content tagging component, a parameter associated with the secondary content data; and
providing, via the indicating component, the indication to the user when the output component outputs the primary content data to the content providing device and the analyzing component generates the activation signal.

15. A non-transitory, tangible, computer-readable media having computer-readable instructions stored thereon, the computer-readable instructions being capable of being read by a computer access point and being capable of instructing the computer access point to perform a method comprising:
receiving, via a first receiver, primary content data from a primary content source;
receiving, via a second receiver, secondary content data from a secondary content source;
outputting, via an output component, the primary content data and the secondary content data to the content providing device;
analyzing, via an analyzing component, the secondary content data based on a tagged parameter associated with the secondary content data;
generating, via the analyzing component, an activation signal based on the analysis;
providing, via an indicating component, an indication to the user based on the activation signal.

16. The non-transitory, tangible, computer-readable media of claim 15, wherein the computer-readable instructions are capable of instructing the computer to perform the method further comprising:
generating, via a user interface component, a graphic user interface to enable a user to tag the first parameter associated with the secondary content data; and
outputting, via output component, the graphic user interface to the display.

17. The non-transitory, tangible, computer-readable media of claim 16, wherein the computer-readable instructions are capable of instructing the computer to perform the method wherein said generating, via a user interface component, a graphic user interface to enable a user to tag the first parameter associated with the secondary content data comprises generating the graphic user interface to enable a user to tag as the first parameter associated with the secondary content data, one of the group consisting of a speech to song transition, a song to speech transition, audience sound amplitude, audience sound type, metadata, a preference profile and combinations thereof.

18. The non-transitory, tangible, computer-readable media of claim 17, wherein the computer-readable instructions are capable of instructing the computer to perform the method such that
said generating, via a user interface component, a graphic user interface to enable a user to tag the first parameter associated with the secondary content data comprises generating the graphic user interface to enable a user to tag as the first parameter associated with the secondary content data, one of the group consisting of a speech to song transition, a song to speech transition, audience sound type and combinations thereof, and
said analyzing, via an analyzing component, the secondary content data based on the tagged parameter comprises frequency analyzing the secondary content data based on the tagged first parameter and to generate the activation signal based on the frequency analysis.

19. The non-transitory, tangible, computer-readable media of claim 18, wherein the computer-readable instructions are capable of instructing the computer to perform the method such that
said wherein said generating, via a user interface component, a graphic user interface to enable a user to tag the first parameter associated with the secondary content data comprises generating the graphic user interface to enable a user to tag as the first parameter associated with the secondary content data, a preference profile, and
the preference profile includes one of the group consisting of program title, program genre, program viewing times, program channels, and program broadcast characteristics.

20. The non-transitory, tangible, computer-readable media of claim 15, wherein the computer-readable instructions are capable of instructing the computer to perform the method further comprising:
storing, via a memory buffer operable to store a predetermined amount of the secondary content data; and
outputting, via a trick play component, the secondary content data from the memory buffer to the display.
